(19) United States
(12) Patent Application Publication
(10) Pub. No.: US 2024/0208628 A1
(43) Pub. Date: Jun. 27, 2024

(54) OUTBOARD MOTOR

(71) Applicant: YAMAHA HATSUDOKI KABUSHIKI KAISHA, Iwata-shi (JP)

(72) Inventor: Yoshihiko OKABE, Shizuoka (JP)

(21) Appl. No.: 18/383,046

(22) Filed: Oct. 24, 2023

(30) Foreign Application Priority Data
Dec. 23, 2022 (JP) 2022-206222

(51) Int. Cl. B63H 20/28; B63H 20/14; B63H 21/17

(52) U.S. Cl. CPC B63H 20/28; B63H 20/14; B63H 21/17

(57) ABSTRACT

An outboard motor includes an electric motor, a drive shaft to be rotationally driven by the electric motor, a propeller, a propeller shaft to rotate together with the propeller, a gear mechanism to transmit rotation of the drive shaft to the propeller shaft, a cooling water flow path through which cooling water flows, and a water pump to pump the cooling water into the cooling water flow path. The water pump includes an impeller and a pump shaft to rotate together with the impeller, and the pump shaft is coaxial with the propeller shaft and rotatable together with the propeller shaft.

### CROSS REFERENCE TO RELATED APPLICATIONS

This application claims the benefit of priority to Japanese Patent Application No. 2022-206222 filed on Dec. 23, 2022. The entire contents of this application are hereby incorporated herein by reference.

### BACKGROUND OF THE INVENTION

### 1. Field of the Invention

The technologies disclosed herein relate to an outboard motor.

### 2. Description of the Related Art

Generally, outboard motors are equipped with a water pump to pump cooling water to cool the engine. The water pump includes an impeller or the like attached to a drive shaft. When the engine is driven, the impeller rotates together with the rotation of the drive shaft, and cooling water is pumped into the engine (see JP 2015-145137 A).

In the water pump of the above configuration, the impeller is attached to the drive shaft and driven by the rotation of the drive shaft, which restricts the installation position of the water pump and reduces the design flexibility.

### SUMMARY OF THE INVENTION

An outboard motor according to a preferred embodiment of the present invention includes a drive unit, a drive shaft to be rotationally driven by the drive unit, a propeller, a propeller shaft to rotate together with the propeller, a transmission to transmit rotation of the drive shaft to the propeller shaft, a cooling water flow path through which cooling water flows, and a water pump to pump the cooling water into the cooling water flow path, wherein the water pump includes an impeller and a pump shaft to rotate together with the impeller, and the pump shaft is coaxial with the propeller shaft and rotatable together with the propeller shaft.

According to the above configuration, the water pump is driven by the transmission of rotation of the propeller shaft which allows the water pump to be installed near the propeller shaft where there is more space than around the drive shaft thus increasing design flexibility.

In the outboard motor, the drive shaft may be rotatable in both a forward direction and a reverse direction opposite to the forward direction, and the water pump may be a non-volumetric pump.

The drive shaft, which is able to rotate in both the forward and reverse directions, eliminates the need for a clutch such as a dog clutch thus providing an even larger space around the propeller shaft. This space can be used to accommodate the water pump eliminating the need for a larger outboard motor and optimizing the arrangement of the components necessary to transport the cooling water. In addition, since the non-volumetric pump has no restriction on the direction of rotation, it is suitable as a pump connected to a drive shaft that is able to rotate in both the forward and reverse directions.

In the outboard motor, the drive unit may be an electric motor driven by electricity supplied from a power source.

In the outboard motor, the water pump may be a centrifugal pump.

In the outboard motor, the pump shaft may be detachably connected to the propeller shaft.

According to such a configuration, the pump shaft is able to be detached from the propeller shaft for maintenance, which facilitates maintenance work.

In the outboard motor, the outboard motor may further include a joint to connect the propeller shaft and the pump shaft, the propeller shaft may include a first coupling, the pump shaft may include a second coupling, and the joint may include a first coupling receiver coupled to the first coupling and a second coupling receiver coupled to the second coupling.

According to this configuration, when a vibration or bending load is applied to the propeller shaft, the vibration or load is mainly received by the joint thus reducing the load on the pump shaft.

In the outboard motor, the first coupling and the second coupling may have an identical or substantially identical shape, and the first coupling receiver and the second coupling receiver may have an identical or substantially identical shape.

According to this configuration, the propeller shaft and the pump shaft can be assembled to the joint without paying attention to the orientation of the joint thus facilitating the assembly work.

In the outboard motor, the first coupling may be a first spline shaft extending along a rotation axis of the propeller shaft, and the first coupling receiver may be a first spline hole to receive the first spline shaft, and the second coupling may be a second spline shaft extending along a rotation axis of the pump shaft, and the second coupling receiver may be a second spline hole to receive the second spline shaft.

This configuration allows the pump shaft to be detachably connected to and rotate together with the propeller shaft.

In the outboard motor, the propeller shaft may include the first spline shaft, the pump shaft may include the second spline shaft, and the joint may include the first spline hole and the second spline hole.

The arrangement of the spline holes, which are more difficult to machine than the spline shaft, in the joint, which is a separate member from the propeller shaft and the pump shaft and is able to be smaller and shorter than the propeller shaft and the pump shaft, facilitates manufacturing.

In the outboard motor, the joint may include a spline hole extending an entire length between first and second ends, a portion of the spline hole adjacent to a first end may be the first spline hole, and a portion of the spline hole adjacent to a second end may be the second spline hole.

This configuration simplifies the joint to facilitate the manufacturing process.

In the outboard motor, one of the propeller shaft and the pump shaft may include a third coupling, and the other of the propeller shaft and the pump shaft may include a third coupling receiver that is coupled to the third coupling.

According to this configuration, the pump shaft is directly connected to the propeller shaft thus avoiding an increase in the number of parts and avoiding a complicated manufacturing process.

In the outboard motor, the third coupling may be a third spline shaft extending along the rotation axis of the propeller shaft, and the third coupling receiver may be a third spline hole to receive the third spline shaft.

This configuration allows the pump shaft to be detachably connected to and rotate together with the propeller shaft.

In the outboard motor, the pump shaft may include a third spline shaft, and the propeller shaft may include a third spline hole.

Generally, the propeller shaft is thicker than the pump shaft because it carries a greater load than the pump shaft. Therefore, it is easier to provide the third spline hole in the propeller shaft than to provide the third spline hole in the pump shaft thus avoiding a complicated manufacturing process.

An outboard motor according to another preferred embodiment of the present invention includes a drive unit, a drive shaft to be rotationally driven by the drive unit, a propeller, a propeller shaft to rotate together with the propeller, a transmission to transmit rotation of the drive shaft to the propeller shaft, a cooling water flow path through which cooling water flows, and a water pump to pump the cooling water into the cooling water flow path, wherein the water pump includes an impeller and a pump shaft to rotate together with the impeller, and the pump shaft is rotatable by transmitting the rotation of the propeller shaft.

In the above configuration, the water pump is driven by transmitting the rotation of the propeller shaft which allows the water pump to be installed near the propeller shaft where there is more space than around the drive shaft thus increasing design flexibility.

The preferred embodiments disclosed herein provide outboard motors with high flexibility in water pump design.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view schematically illustrating a configuration of a boat according to a first preferred embodiment of the present invention.

FIG. 2 is a side view schematically illustrating a configuration of an outboard motor according to the first preferred embodiment of the present invention.

FIG. 3 is a partially enlarged cross-sectional view of an outboard motor according to the first preferred embodiment of the present invention, showing a partially enlarged cross-section cut at the position indicated by line III-III in FIG. 1.

FIG. 4 is an enlarged cross-sectional view of the portion indicated by frame F in FIG. 3.

FIG. 5 is a partially enlarged cross-sectional view of an outboard motor according to a second preferred embodiment of the present invention, showing the same area as in FIG. 4 enlarged.

### DETAILED DESCRIPTION OF THE PREFERRED EMBODIMENTS

Specific preferred embodiments of the technologies disclosed by this specification are described below with reference to the drawings. The present invention is not limited to these preferred embodiments but is indicated by the claims, which are intended to include all modifications within the meaning and scope equivalent to the claims.

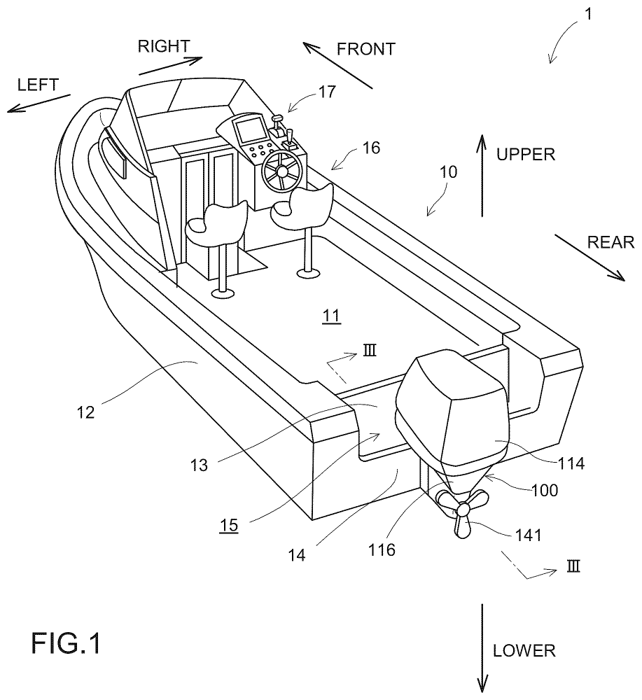

A first preferred embodiment of the present invention will be described with reference to FIGS. 1 to 4. A boat 1 according to the first preferred embodiment includes a hull 10 and an outboard motor 100, as shown in FIG. 1. FIG. 1 and the other figures to follow show arrows representing each direction with respect to the position of the boat 1. More specifically, each drawing shows arrows representing front (FRONT), rear (REAR), left (LEFT), right (RIGHT), upper (UPPER), and lower (LOWER) directions. The front-rear, left-right, and upper-lower (vertical) directions are orthogonal to each other.

The hull 10 is a portion of the boat 1 for occupants to ride. As shown in FIG. 1, the hull 10 includes a hull body 12 including a living space 11, a pilot seat 16 installed in the living space 11, and an operating device 17 installed near the pilot seat 16. The operating device 17 maneuvers the boat and includes, e.g., a steering wheel, a shift throttle lever, a joystick, a monitor, and an input device. The hull 10 also includes a partition wall 13 that partitions the rear end of the living space 11 and a transom 14 positioned at the rear end of the hull 10. In the front-rear direction, there is a space 15 between the transom 14 and the partition wall 13.

The outboard motor 100 generates thrust to propel the boat 1. The outboard motor 100 in the present preferred embodiment is an electric outboard motor driven by an electric motor 120 (an example of a drive unit). The outboard motor 100 in the reference attitude will be described below unless otherwise specified. The reference attitude is the attitude of the outboard motor 100 when the boat 1 is cruising (attitude shown in FIG. 1), in which the rotation axis Ad of the drive shaft 130 (described below) extends in the upper-lower direction and the rotation axis Apr of the propeller shaft 140 extends in the front-rear direction. The front-rear direction, the left-right direction, and the upper-lower direction are defined based on the outboard motor 100 in the reference attitude.

As shown in FIG. 1, the outboard motor 100 is attached to the transom 14 located at the rear (stern) of the hull 10. The outboard motor 100 includes an outboard motor main body 110 and a suspension device 150.

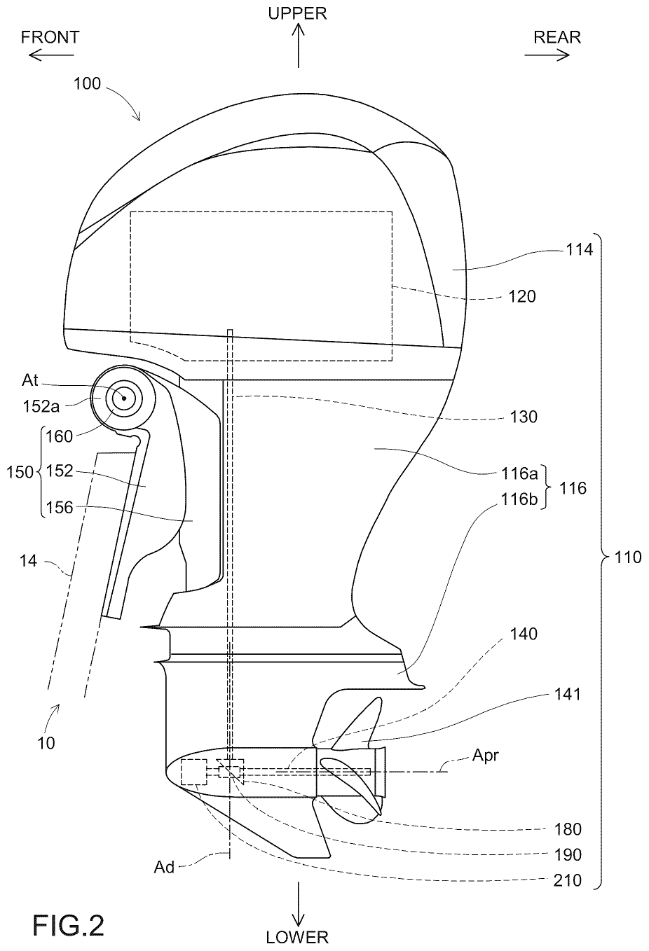

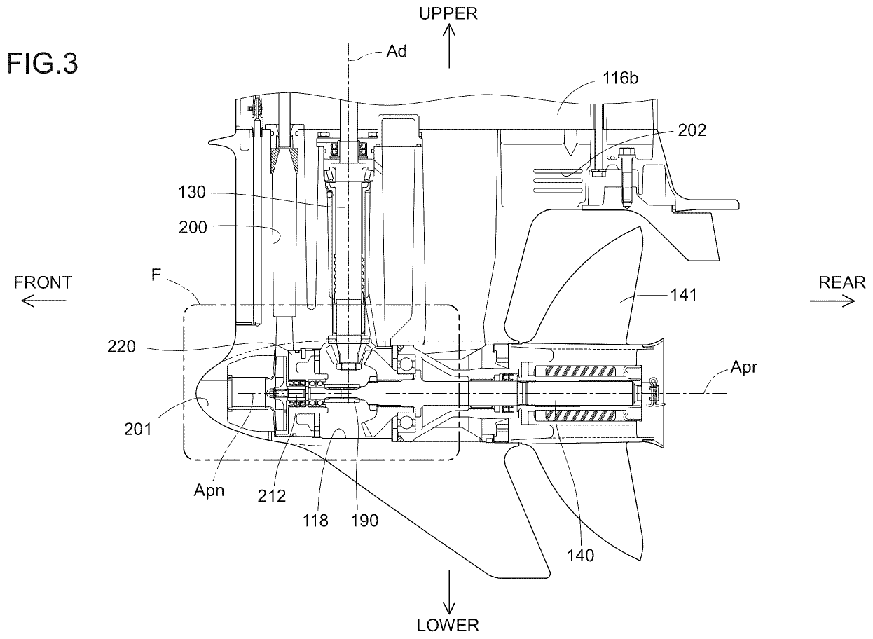

As shown in FIGS. 2 and 3, the outboard motor main body 110 includes a cowl 114, a casing 116, an electric motor 120, a drive shaft 130, a propeller 141, a propeller shaft 140, a cooling water flow path 200, a water pump 210, a gear mechanism 180 (an example of the transmission), and a joint 190.

As shown in FIG. 2, the cowl 114 is a housing located on top of the outboard motor main body 110. The casing 116 includes an upper case 116a and a lower case 116b, as shown in FIG. 2. The upper case 116a is a housing located below the cowl 114. The lower case 116b is a housing located below the upper case 116a.

The lower case 116b includes a gear chamber 118 that stores oil therein and houses the gear mechanism 180, as shown in FIG. 3.

The electric motor 120 is driven by electric power supplied from a battery (power source). The electric motor 120 includes a rotor including a permanent magnet, a stator including a coil to which the battery power is supplied, and a motor housing that houses the rotor and stator. The electric motor 120 is located inside the cowl 114. The battery may be located inside the cowl 114 or inside the hull 10.

The drive shaft 130 is a rod-shaped member extending downward from the electric motor 120 and housed within the casing 116, as shown in FIG. 2. The drive shaft 130 is arranged in an attitude in which its rotation axis Ad extends in the upper-lower direction.

The drive shaft 130 rotates around the rotation axis Ad by the rotational driving force of the electric motor 120. Since the electric motor 120 is able to rotate in both forward and reverse directions, the drive shaft 130 is also able to rotate around the rotation axis line Ad in both the forward direction to move the boat 1 forward and the reverse direction to move the boat 1 backward opposite to the forward direction, according to the rotational driving direction of the electric motor 120.

The propeller 141 is a rotating body including a plurality of blades. The propeller 141 generates thrust by rotation.

The propeller shaft 140 is a rod-shaped member and extends in the front-rear direction inside the lower case 116b, as shown in FIGS. 2, 3, and 4. The propeller shaft 140 is rotatably supported by the lower case 116b via a bearing 142. The rear end of the propeller shaft 140 protrudes rearwardly from the lower case 116b, and the propeller 141 is attached to this rear end. As the propeller shaft 140 rotates around the rotation axis Apr, the propeller 141 also rotates.

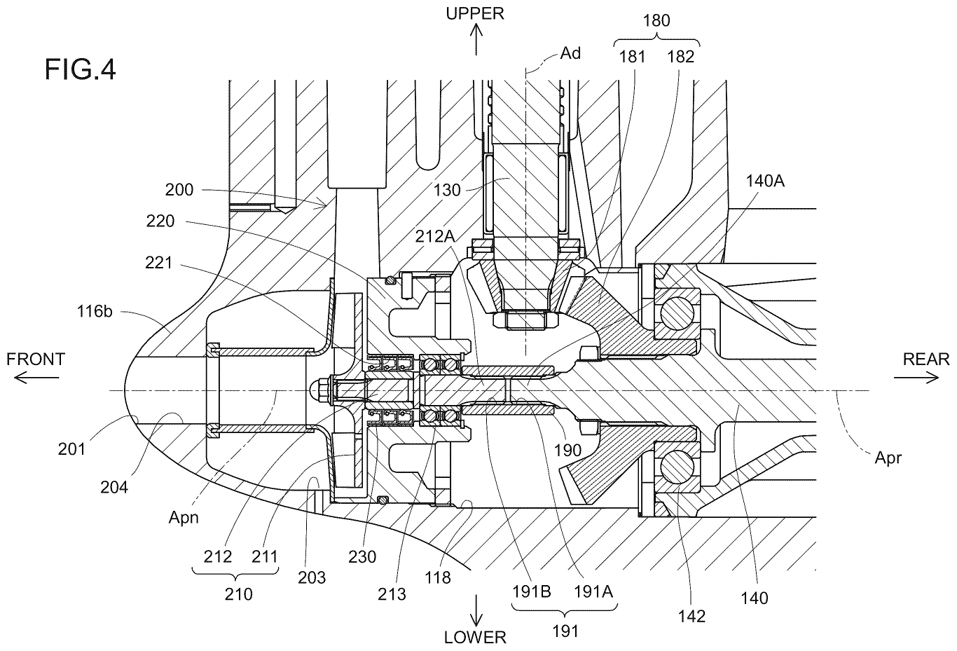

The front end of the propeller shaft 140 includes a first spline shaft 140A (an example of the first coupling), as shown in FIG. 4. The first spline shaft 140A is a round rod-shaped shaft extending along the rotation axis Apr with a plurality of spline teeth on its outer surface.

The cooling water flow path 200 is located inside the outboard motor main body 110. The cooling water flow path 200 includes a channel through which cooling water (seawater, lake water, and river water, among others) taken from outside the outboard motor 100 flows. The cooling water flow path 200 includes an intake port 201 that opens on the outer surface of the lower case 116b to take in cooling water into the interior and a drain port 202 that also opens on the outer surface of the lower case 116b to discharge cooling water to the exterior. The cooling water flow path 200 extends from the intake port 201 through the periphery of the electric motor 120 to the drain port 202. The intake port 201 is located below the waterline when the boat 1 is cruising, i.e., when the outboard motor 100 is in the reference attitude. The intake port 201 is open at the front end of the lower case 116b.

As shown in FIG. 4, a portion of the cooling water flow path 200 includes a pump chamber 203. The pump chamber 203 is located in front of the gear chamber 118 in the lower case 116b and is separated from the gear chamber 118 by a partition 220. The partition 220 includes a shaft hole 221 that is connected to the pump chamber 203 and the gear chamber 118.

The water pump 210 is a non-volumetric pump having an impeller 211 and a pump shaft 212 that rotates together with the impeller 211, as shown in FIG. 4. In the present preferred embodiment, a centrifugal pump is exemplified as the water pump 210.

The impeller 211 includes a rotating body including a plurality of blades and is located inside the pump chamber 203. The pump shaft 212 is a rod-shaped member and extends in a front-rear direction. The pump shaft 212 is inserted into the shaft hole 221 and is supported by the partition 220 in a rotatable manner via a bearing 213. The rotation axis Apn of the pump shaft 212 coincides with the rotation axis Apr of the propeller shaft 140. The front end of the pump shaft 212 is located inside the pump chamber 203, where the impeller 211 is mounted. In other words, the water pump 210 (specifically, the pump shaft 212 and impeller 211) is located on the rotation axis Apr of the propeller shaft 140. As the pump shaft 212 rotates around the rotation axis Apn, the impeller 211 also rotates.

The rear end of the pump shaft 212 includes a second spline shaft 212A (an example of the second coupling) that is arranged inside the gear chamber 118. The second spline shaft 212A is a round rod-shaped shaft extending along the rotation axis Apn with a plurality of spline teeth on its outer surface. The second spline shaft 212A has a shape that is identical or substantially identical to that of the first spline shaft 140A. In other words, the outer diameter, length, and spline tooth arrangement and shape of the second spline shaft 212A and the first spline shaft 140A are identical or substantially identical.

The portion of the cooling water flow path 200 from the intake port 201 to the water pump 210, i.e., the portion located between the intake port 201 and the pump chamber 203 (inlet channel 204), is located in front of the water pump 210 and extends along the rotation axis Apn of the pump shaft 212, as shown in FIG. 4.

Inside the shaft hole 221, as shown in FIG. 4, a plurality of seals 230 are arranged on the outer surface of the pump shaft 212 to fill the gap between the inner surface of the shaft hole 221 and the pump shaft 212. Each seal 230 is circular in shape, made of a material such as rubber having elasticity, and encircles the pump shaft 212 all the way around. The plurality of seals 230 are arranged in line along the rotation axis Apn of the pump shaft 212. These seals 230 prevent cooling water flowing into the pump chamber 203 from entering the gear chamber 118 through the gap between the inner circumferential surface of the shaft hole 221 and the pump shaft 212.

The gear mechanism 180 transmits the rotation of the drive shaft 130 to the propeller shaft 140.

The gear mechanism 180 includes a first gear 181 and a second gear 182, as shown in FIG. 4. The first gear 181 is coaxially mounted to the drive shaft 130 and rotates together with the drive shaft 130. The second gear 182 is coaxially mounted to the propeller shaft 140 and rotates together with the propeller shaft 140. The second gear 182 meshes with the first gear 181. The first gear 181 and the second gear 182 are, e.g., bevel gears.

The gear mechanism 180 is located inside the gear chamber 118. The two gears 181 and 182 are lubricated by oil provided inside the gear chamber 118.

As described above, the drive shaft 130, which is rotationally driven by the electric motor 120, is able to rotate in both the forward and reverse directions thus eliminating the need for a clutch mechanism, such as a dog clutch, to switch the direction of rotation of the propeller shaft 140. Therefore, there is a relatively large space around the propeller shaft 140 in the lower case 116b, and this space can be used to accommodate the water pump 210 and gear mechanism 180. This optimizes the arrangement of the components necessary to transport cooling water while avoiding an increase in the size of the outboard motor 100. The space can also accommodate the length of the pump shaft 212 necessary to position the multiple seals 230, which reliably prevents cooling water from entering the gear chamber 118.

The joint 190 engages with the first spline shaft 140A and the second spline shaft 212A and connects the propeller shaft 140 and the pump shaft 212.

The joint 190 is cylindrical or substantially cylindrical with openings at both ends and includes a spline hole 191 extending from a first end to a second end. The spline hole 191 includes a plurality of spline grooves arranged on the inner surface. In the spline hole 191, the portion adjacent to the first end of the joint 190 (right end of FIG. 4) includes a first spline hole 191A (first coupling receiver) that receives the first spline shaft 140A, and the portion adjacent to the second end of the joint 190 (left end of FIG. 4) includes a second spline hole 191B (second coupling receiver) that receives the second spline shaft 212A. The first spline hole 191A and the second spline hole 191B are located at first and second ends of the spline hole 191, and have shapes that are identical or substantially identical to each other. In other words, the first spline hole 191A and the second spline hole 191B are equal or substantially equal in their inner diameter and spline groove arrangement.

The first spline shaft 140A is fitted into the first spline hole 191A, and each spline tooth of the first spline shaft 140A meshes with each spline groove of the first spline hole 191A. The second spline shaft 212A is fitted into the second spline hole 191B, and each spline tooth on the second spline shaft 212A meshes with each spline groove on the second spline hole 191B. As a result, the propeller shaft 140, joint 190, and pump shaft 212 rotate together. In other words, the pump shaft 212 is connected to the propeller shaft 140 via the joint 190 so that they rotate together. The pump shaft 212 is coaxial with the propeller shaft 140.

By using the first end and the second end of the single spline hole 191 as the first spline hole 191A and the second spline hole 191B, the joint 190 has a simple shape, and the manufacturing process is simplified. Furthermore, the arrangement of the spline hole 191, which is more difficult to machine than the spline shafts 140A and 212A, in the joint 190, which is a separate member from the propeller shaft 140 and pump shaft 212 and can be smaller and shorter than the propeller shaft 140 and pump shaft 212, facilitates manufacturing.

In addition, since the first spline shaft 140A and the second spline shaft 212A have an identical or substantially identical shape, and the first spline hole 191A and the second spline hole 191B have an identical or substantially identical shape, when connecting the pump shaft 212 and the propeller shaft 140 with the joint 190, the joint 190 is able to be assembled without paying attention to the orientation of the joint 190, thus facilitating the assembly work.

The pump shaft 212 is assembled to the propeller shaft 140 such that the pump shaft 212 can be attached to and detached from the propeller shaft 140 by inserting/removing the first spline shaft 140A into/from the first spline hole 191A and inserting/removing the second spline shaft 212A into/from the second spline hole 191B. This allows the pump shaft 212 to be removed from the propeller shaft 140 for maintenance thus facilitating maintenance work.

The suspension device 150 suspends the outboard motor main body 110 on the hull 10. The suspension device 150 includes a pair of left and right clamp brackets 152, a tilt shaft 160, and a connection bracket 156, as shown in FIG. 2.

The pair of left and right clamp brackets 152 are disposed behind the hull 10 in a state separated from each other in the left-right direction and are fixed to the transom 14 of the hull 10 by using, e.g., bolts. Each clamp bracket 152 includes a cylindrical supporting portion 152a provided with a through-hole extending in the left-right direction.

The tilt shaft 160 is a rod-shaped member. The tilt shaft 160 is rotatably supported in the through-hole of the supporting portion 152a of the clamp bracket 152. The tilt axis At, which is the center line of the tilt shaft 160, defines an axis in the horizontal direction (left-right direction) during the tilting action of the outboard motor 100.

The connection bracket 156 is sandwiched between the pair of clamp brackets 152 and is supported by the supporting portion 152a of the clamp bracket 152 via the tilt shaft 160 in such a manner that the connection bracket 156 is able to rotate around the tilt axis At. The connection bracket 156 is fixed to the outboard motor main body 110. The connection bracket 156 is rotationally driven around the tilt axis At with respect to the clamp bracket 152 by a tilt device (not shown) including an actuator such as, e.g., a hydraulic cylinder.

When the connection bracket 156 rotates about the tilt axis At with respect to the clamp bracket 152, the outboard motor main body 110 fixed to the connection bracket 156 also rotates about the tilt axis At. This achieves the tilting action of rotating the outboard motor main body 110 in the upper-lower direction with respect to the hull 10. Due to this tilting action, the outboard motor 100 can change the angle around the tilt axis At of the outboard motor main body 110 in the range from the tilt-down state in which the propeller 141 is located under the waterline (the state in which the outboard motor 100 is in the reference attitude: the state shown in FIG. 1) to the tilt-up state in which the propeller 141 is above the waterline. Trimming action to adjust the attitude of the boat 1 during cruising can also be performed by adjusting the angle around the tilt axis At of the outboard motor main body 110.

When the boat 1 is cruising, the outboard motor 100 is placed in the tilt-down state, and the lower case 116b and the propeller 141 are positioned below the waterline. The intake port 201, inlet channel 204, pump chamber 203, and water pump 210 located inside the lower case 116b are also below the waterline, and cooling water flows into the pump chamber 203 from outside through the intake port 201 and inlet channel 204.

When the electric motor 120 is driven, the drive shaft 130 rotates around the rotation axis Ad due to the rotational driving force of the electric motor 120.

The rotation of the drive shaft 130 is transmitted to the propeller shaft 140 via the gear mechanism 180. When the gear mechanism 180 transmits the forward rotation of the drive shaft 130 to the propeller shaft 140, the propeller 141 rotating together with the propeller shaft 140 generates thrust in the forward direction. When the gear mechanism 180 transmits the reverse rotation of the drive shaft 130 to the propeller shaft 140, the propeller 141 rotating together with the propeller shaft 140 generates thrust in the backward direction.

The joint 190 rotates as the drive shaft 130 rotates, and the pump shaft 212 also rotates. In other words, the rotation of the drive shaft 130 is transmitted to the propeller shaft 140 by the gear mechanism 180 and from the propeller shaft 140 to the pump shaft 212 via the joint 190. Then, the impeller 211 rotates together with the pump shaft 212. Cooling water taken in from the intake port 201 is pumped through the cooling water flow path 200 by centrifugal force generated by the rotation of the impeller 211, and is supplied around the electric motor 120 to cool the electric motor 120. In addition to the electric motor 120, the cooling water may also cool the battery, inverter, and reduction gears, among others, located inside the outboard motor main body 110. After being used for cooling, the cooling water is discharged to the outside through the drain port 202.

As the propeller shaft 140 rotates in both the forward and reverse directions, the pump shaft 212 also rotates around the rotation axis Apn in both the direction of rotation associated with the forward rotation of the propeller shaft 140 and the direction of rotation associated with the reverse rotation of the propeller shaft 140. The water pump 210, which is a non-volumetric pump with no restriction on its direction of rotation, operates normally no matter which direction the propeller shaft 140 rotates.

Thus, the pump shaft 212 is connected to the propeller shaft 140 so that they rotate together. The rotation of the drive shaft 130 is transmitted through the gear mechanism 180 to the propeller shaft 140 and then through the joint 190 to the pump shaft 212 to drive the water pump 210. According to this configuration, the water pump 210 is driven by the transmission of the rotation of the propeller shaft 140, which allows the water pump 210 to be installed near the propeller shaft 140 where there is more space than around the drive shaft 130, thus increasing design flexibility.

In addition, the propeller shaft 140 is connected to the pump shaft 212 via the joint 190. According to this configuration, when a vibration or bending load is applied to the propeller shaft 140, the vibration or load is mainly received by the joint 190 thus reducing the load on the pump shaft 212.

As the drive shaft 130 rotates in both the forward and reverse directions, the pump shaft 212 also rotates around the rotation axis Apn in both the direction of rotation associated with the forward direction of the drive shaft 130 and the direction of rotation associated with the reverse direction of the drive shaft 130. The water pump 210, which is a non-volumetric pump with no restriction on the direction of rotation, operates normally no matter which direction the drive shaft 130 rotates.

As described above, the outboard motor 100 of the present preferred embodiment is an outboard motor 100 mounted on the hull 10, including the electric motor 120, the drive shaft 130 to be rotationally driven by the electric motor 120, the propeller 141, the propeller shaft 140 to rotate together with the propeller 141, the gear mechanism 180 to transmit rotation of the drive shaft 130 to the propeller shaft 140, the cooling water flow path 200 through which cooling water flows, and the water pump 210 to pump the cooling water into the cooling water flow path 200, wherein the water pump 210 includes an impeller 211 and a pump shaft 212 to rotate together with the impeller 211, and the pump shaft 212 is coaxial with the propeller shaft 140 and rotatable together with the propeller shaft 140.

According to the above configuration, the water pump 210 is driven by the transmission of the rotation of the propeller shaft 140, which allows the water pump 210 to be installed near the propeller shaft 140, where there is more space than around the drive shaft 130 thus increasing design flexibility.

In addition, the drive shaft 130 is able to rotate in both the forward direction and the reverse direction opposite to the forward direction, and the water pump 210 is a non-volumetric pump.

According to this configuration, the drive shaft 130, which is able to rotate in both the forward and reverse directions, eliminates the need for a clutch mechanism such as a dog clutch to switch the direction of rotation of the propeller shaft 140, thus providing a relatively large space around the propeller shaft 140. This space can be used to accommodate the water pump 210, avoiding an increase in the size of the outboard motor 100 and optimizing the arrangement of the components necessary to transport the cooling water. In addition, since the non-volumetric water pump 210 has no restrictions on the direction of rotation, it is suitable as a pump, the rotation of which is transmitted from the drive shaft 130 that is able to rotate in both the forward and reverse directions.

The pump shaft 212 is detachably connected to the propeller shaft 140. According to this configuration, the pump shaft 212 can be detached from the propeller shaft 140 for maintenance, which facilitates maintenance work.

The outboard motor 100 is further provided with the joint 190 connecting the propeller shaft 140 and the pump shaft 212, the propeller shaft 140 includes the first spline shaft 140A, the pump shaft 212 includes the second spline shaft 212A, and the joint 190 includes a first spline hole 191A coupled to the first spline shaft 140A and a second spline hole 191B coupled to the second spline shaft 212A.

According to this configuration, when a vibration or bending load is applied to the propeller shaft 140, the vibration or load is mainly received by the joint 190, thus reducing the load on the pump shaft 212.

The first spline shaft 140A and the second spline shaft 212A may have an identical or substantially identical shape, and the first spline hole 191A and the second spline hole 191B may have an identical or substantially identical shape.

This configuration allows the pump shaft 212 to be detachably connected to and rotate together with the propeller shaft 140. In addition, the propeller shaft 140 and the pump shaft 212 can be assembled to the joint 190 without paying attention to the orientation of the joint 190, thus facilitating the assembly work. Furthermore, the arrangement of the spline hole 191, which is more difficult to machine than the spline shafts 140A and 212A, in the joint 190, which is a separate member from the propeller shaft 140 and pump shaft 212 and can be smaller and shorter than the propeller shaft 140 and pump shaft 212, facilitates manufacturing.

The joint 190 includes the spline holes 191 extending over the entire length between the first and second ends, with the portion of the spline hole 191 adjacent to the first end defining the first spline hole 191A and the portion of the spline hole 191 adjacent to the second end defining the second spline hole 191B. This configuration simplifies the joint 190 to facilitate the manufacturing process.

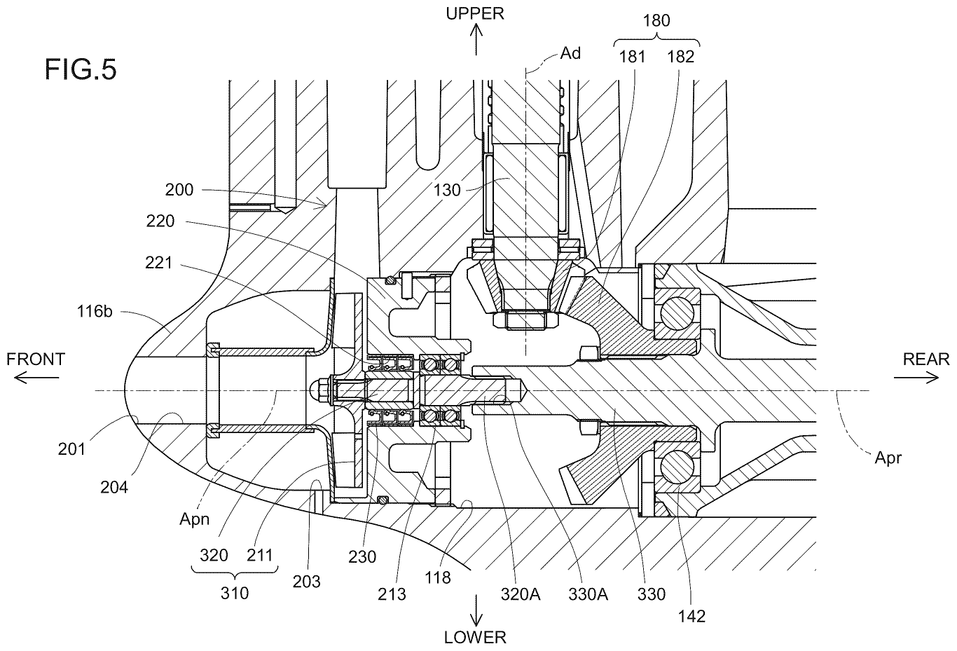

A second preferred embodiment of the present invention will be explained with reference to FIG. 5. The outboard motor in this preferred embodiment differs from that of the first preferred embodiment in that the pump shaft 320 is directly connected to the propeller shaft 330. In this preferred embodiment, the same configuration as in first preferred embodiment will be indicated by the same reference characters, and explanation thereof will be omitted.

As in the first preferred embodiment, the propeller shaft 330 is a rod-shaped member and is rotatably supported by the lower case 116b via the bearing 142. The rear end of the propeller shaft 330 protrudes rearwardly from the lower case 116b, and the propeller 141 is attached to this rear end. As the propeller shaft 330 rotates around the rotation axis Apr, the propeller 141 also rotates.

The front end of the propeller shaft 330 includes a third spline hole 330A (an example of the third coupling receiver). A plurality of spline grooves extending along the rotation axis Apr are arranged on the inner surface of the third spline hole 330A.

As in the first preferred embodiment, the water pump 310 is a non-volumetric pump having an impeller 211 and a pump shaft 320 that rotates together with the impeller 211. The pump shaft 320 is a rod-shaped member and extends along the rotation axis Apr of the propeller shaft 330. In other words, the pump shaft 320 is coaxial with the propeller shaft 330. The rear end of the pump shaft 320 includes the third spline shaft 320A (an example of the third coupling). The third spline shaft 320A is a round rod-shaped shaft extending along the rotation axis Apn and including a plurality of spline teeth on its outer surface.

The third spline shaft 320A is fitted into the third spline hole 330A, and each spline tooth of the third spline shaft 320A meshes with each spline groove of the third spline hole 330. This allows the pump shaft 320 to be detachably connected to and rotate together with the propeller shaft 330. The pump shaft 320 is coaxial with the propeller shaft 140.

Rotation of the drive shaft 130 is transmitted to the propeller shaft 330 via the gear mechanism 180 causing the propeller shaft 330 to rotate, which is further transmitted to the pump shaft 320 causing the pump shaft 320 to rotate. This drives the water pump 310.

Thus, in this preferred embodiment, the pump shaft 320 includes a third spline shaft 320A, and the propeller shaft 330 includes a third spline hole 330A that is coupled to the third spline shaft 320A.

According to this configuration, the pump shaft 320 is directly connected to the propeller shaft 330, thus avoiding an increase in the number of components and avoiding a complicated manufacturing process. In addition, this configuration allows the pump shaft 320 to be easily detachably connected to rotate together with the propeller shaft 330.

Furthermore, the propeller shaft 330 is thicker than the pump shaft 320 because it carries a greater load than the pump shaft 320. Therefore, in terms of the manufacturing process, it is easier and less complicated to make the third spline hole 330A on the propeller shaft 330 than on the pump shaft 320.

In the above preferred embodiments, as an example, the electric outboard motor 100 is driven by the electric motor 120, but the drive unit of the outboard motor does not have to be an electric motor and may be, e.g., an internal combustion engine.

In the above preferred embodiments, the drive shaft 130 is rotatable in both the forward and reverse directions according to the rotational drive direction of the electric motor 120, but the outboard motor may include an internal combustion engine as a drive unit and a shift mechanism to switch the rotational direction of the drive shaft.

In the first preferred embodiment, the propeller shaft 140 includes the first spline shaft 140A, and the joint 190 includes the first spline hole 191A, but the propeller shaft may include the first spline hole, and the joint may include the first spline shaft. Also, in the first preferred embodiment, the pump shaft 212 includes the second spline shaft 212A and the joint 190 includes the second spline hole 191B, but the pump shaft may include the second spline hole and the joint may include the second spline shaft.

In the first preferred embodiment, the first spline shaft 140A and the second spline shaft 212A have an identical shape or substantially identical shape, but the first spline shaft and the second spline shaft may have different outer diameters and lengths. In that case, the first spline hole and the second spline hole may also have a shape corresponding to the first spline shaft and the second spline shaft, respectively.

In the first preferred embodiment, the propeller shaft 140 and the joint 190 are connected by fitting the first spline shaft 140A into the first spline hole 191A, but the connection between the propeller shaft and joint is not limited to that by the spline shaft and spline hole and may also be implemented by a bolt and nut, for example. The same applies to the connection between the pump shaft and the joint. The same also applies to the connection between the propeller shaft and pump shaft in the second preferred embodiment.

In the above preferred embodiments, the pump shafts 212 and 320 are detachably connected to the propeller shafts 140 and 330, but this connection may be made in a non-detachable manner, for example, the joint and the propeller shaft or the joint and the pump shaft may be connected by welding.

In the above preferred embodiments, a plurality of seals 230 are attached to the pump shaft 212, but the number of seals is freely selectable and may be, e.g., only one.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An outboard motor to be mounted on a hull, the outboard motor comprising:
a drive unit;
a drive shaft to be rotationally driven by the drive unit;
a propeller;
a propeller shaft to rotate together with the propeller;
a transmission mechanism to transmit rotation of the drive shaft to the propeller shaft;
a cooling water flow path through which cooling water flows; and
a water pump to pump the cooling water into the cooling water flow path; wherein
the water pump includes:
an impeller; and
a pump shaft to rotate together with the impeller; and
the pump shaft is coaxial with the propeller shaft and rotatable together with the propeller shaft.

2. The outboard motor according to claim 1, wherein
the drive shaft is rotatable in both a forward direction and a reverse direction opposite to the forward direction; and
the water pump is a non-volumetric pump.

3. The outboard motor according to claim 2, wherein the drive unit is an electric motor to be driven by electric power supplied from a power source.

4. The outboard motor according to claim 2, wherein the water pump is a centrifugal pump.

5. The outboard motor according to claim 1, wherein the pump shaft is detachably connected to the propeller shaft.

6. The outboard motor according to claim 1, further comprising:
a joint to connect the propeller shaft to the pump shaft; wherein
the propeller shaft includes a first coupling;
the pump shaft includes a second coupling; and
the joint includes a first coupling receiver coupled to the first coupling and a second coupling receiver coupled to the second coupling.

7. The outboard motor according to claim 6, wherein the first coupling and the second coupling have an identical or substantially identical shape, and the first coupling receiver and the second coupling receiver have an identical or substantially identical shape.

8. The outboard motor according to claim 6, wherein
the first coupling includes a first spline shaft extending along a rotation axis of the propeller shaft, and the first coupling receiver includes a first spline hole to receive the first spline shaft; and
the second coupling includes a second spline shaft extending along a rotation axis of the pump shaft, and the second coupling receiver includes a second spline hole to receive the second spline shaft.

9. The outboard motor according to claim 8, wherein
the propeller shaft includes the first spline shaft;
the pump shaft includes the second spline shaft; and
the joint includes the first spline hole and the second spline hole.

10. The outboard motor according to claim 9, wherein
the joint includes a spline hole extending along an entire length between first and second ends; and
a portion of the spline hole adjacent to the first end includes the first spline hole, and a portion of the spline hole adjacent to the second end includes the second spline hole.

11. The outboard motor according to claim 1, wherein one of the propeller shaft and the pump shaft includes a third coupling, and the other of the propeller shaft and the pump shaft includes a third coupling receiver coupled to the third coupling.

12. The outboard motor according to claim 11, wherein the third coupling includes a third spline shaft extending along a rotation axis of the propeller shaft, and the third coupling receiver includes a third spline hole to receive the third spline shaft.

13. The outboard motor according to claim 12, wherein the pump shaft includes the third spline shaft, and the propeller shaft includes the third spline hole.

14. An outboard motor to be mounted on a hull, the outboard motor comprising:
a drive unit;
a drive shaft to be rotationally driven by the drive unit;
a propeller;
a propeller shaft to rotate together with the propeller;
a transmission to transmit rotation of the drive shaft to the propeller shaft;
a cooling water flow path through which cooling water flows; and
a water pump to pump the cooling water into the cooling water flow path; wherein
the water pump includes:
an impeller; and
a pump shaft to rotate together with the impeller; and
the pump shaft is rotatable by transmitting a rotation of the propeller shaft.

15. A boat comprising:
a hull; and
the outboard motor according to claim 1 attached to a transom at a rear end of the hull.

16. A boat comprising:
a hull; and
the outboard motor according to claim 14 attached to a transom at a rear end of the hull.
